(19) United States
(12) Patent Application Publication
(10) Pub. No.: US 2008/0171824 A1
(43) Pub. Date: Jul. 17, 2008

(54) Polymers filled with highly expanded graphite

(75) Inventors: Robert C. Cieslinski, Midland, MI (US); Parvinder Singh Walia, Midland, MI (US); David H. Bank, Midland, MI (US)

Correspondence Address: The Dow Chemical Company;Gary C. Cohn, P. O. Box 313, Huntingdon Valley, PA, 19006, US

(73) Assignee: Dow Global Technologies, Inc.

(21) Appl. No.: 11/891,204

(22) Filed: Aug. 9, 2007

Related U.S. Application Data
(60) Provisional application No. 60/836,808, filed on Aug. 10, 2006.

(51) Int. Cl. C08K 3/04

(52) U.S. Cl. 524/495

(57) ABSTRACT

Polymers are filled with from 1 to 8% by weight of an expanded graphite having a BET surface area of at least 120 m²/g. Processes for preparing such polymers include forming a dispersion of the expanded graphite in a polymerizable monomer or curable polymer precursor, and polymerizing or curing same in the presence of the expanded graphite. Electroconductive polymers can be prepared in this manner using low levels of the expanded graphite material.

### CROSS REFERENCE TO RELATED APPLICATION

This application claims benefit of U.S. Provisional Application 60/836,808, filed 10 Aug. 2006.

### BACKGROUND OF THE INVENTION

This invention relates to organic polymers filled with highly expanded graphite.

Carbon and graphite are commonly used as fillers in polymer composites. These materials can enhance certain physical properties of the composite, relative to those of the unfilled polymer. For example, the stiffness, coefficient of linear thermal expansion and temperature resistance of the composite all can be increased quite substantially by the presence of carbon or graphite reinforcement.

In many cases the presence of dispersed carbon or graphite also increases the electroconductivity of the composite. This effect is very desirable for many applications. An example of such an application is an automotive body part that is to be painted in a so-called electro-deposition, or “E-coat” process. This process applies a coating to an automotive assembly for corrosion protection via galvanic water-solution immersion. To be usable in this process, the polymer must be somewhat conductive, so a charge can be applied to it during the galvanic coating step. There are many other instances where a somewhat electroconductive polymer is needed.

Several forms of carbon and graphite are available which are useful in these applications. These include powders, flakes, so-called graphite nanotubes, and various types of fibers. Fibers can be short or continuous types.

The electroconductivity of polymers filled with carbon or graphite depends to a significant degree on the formation of a percolation path, through which an electrical current can be carried through the composite. This is usually accomplished more easily when fibers are used, as the individual fibers will either extend continuously through the composite, or in the case of shorter fibers will usually form a network in which individual fibers are in contact with neighboring fibers: The presence of fibers or a fiber network that extends though the composite provides the necessary percolation path through which an electrical current can flow.

In some cases, it is not suitable to use a fibrous reinforcement. There can be several reasons for this, including the somewhat high cost of the fibers, limited techniques that are available to form the composite, the need to use relatively high loadings of the fibers, and the anisotropic physical and sometimes electrical behavior of fiber-reinforced composites. In those cases, the carbon or graphite is used in the form of a particulate.

It is usually more difficult to obtain a good percolation path through the composite using particulate (rather than fiber) carbon or graphite. This is because the particle-to-particle spacing must be quite small in order to establish the needed percolation path through the composite. The small inter-particle spacing is favored by increasing the loading of the carbon or graphite. Increasing the filler loading is economically disadvantageous, and may undesirably diminish some physical properties such as elongation and impact strength.

So-called expanded graphites have been used as fillers for plastics materials. “Expanded” graphites are graphites that have been treated to increase the inter-planar distance between the individual layers that make up the graphite structure. Some of these materials are commercially available, including those sold by GRAFTech Inc., Advanced Energy Technologies Division, Parma, Ohio and HP Material Solutions, Northridge, Calif. These materials are capable of providing both mechanical reinforcement and a measure of electrical conductivity to organic polymers. Another expanded graphite, having a surface area of about 110 m²/g, has been used as a filler for epoxy resins at laboratory scale. However, it is still desirable to provide a more efficient agent that can be used in smaller quantities, particularly for purposes of imparting electroconductivity to a polymer.

Another type of carbonaceous material of interest is carbon nanotubes. These nanotubes are believed to correspond to a single layer of a graphite structure that has been “rolled” to form a tube. The elongated structure of the nanotubes makes them somewhat efficient as reinforcing agents, and in providing electroconductivities. The use of these materials is not practical for most applications because they are prohibitively expensive.

There remains a need to provide for a material that efficiently and inexpensively reinforces and provides electroconductivity to an organic polymer.

### SUMMARY OF THE INVENTION

In one aspect, this invention is a composite comprising a matrix of an organic polymer, the polymer matrix having dispersed therein at least about 1% by weight of expanded graphite particles, based on the weight of the composite, wherein the graphite particles have a surface area of at least 120 m²/g.

In a second aspect, this invention is a dispersion of expanded graphite particles in a polymerizable monomer, the dispersion containing at least about 1% by weight of expanded graphite particles, based on the weight of the dispersion, wherein the graphite particles have a surface area of at least 120 m²/g.

This invention is also a dispersion of expanded graphite particles in a curable resin composition, the dispersion containing at least about 1% by weight of expanded graphite particles, based on the weight of the dispersion, wherein the expanded graphite particles have a surface area of at least 120 m²/g.

This invention is also a polymerization process comprising subjecting a dispersion of expanded graphite particles in at least one polymerizable monomer to conditions sufficient to polymerize the monomer to form a composite comprising a polymer matrix of the polymerized monomer, the polymer matrix having dispersed therein at least about 1% by weight of expanded graphite particles having a surface areas of at least 120 m²/g.

This invention is also a process comprising forming a dispersion of expanded graphite particles in a curable resin composition, and curing the resin composition in the presence of the expanded graphite particles, wherein the dispersion contains at least about 1% by weight of expanded graphite particles, and the expanded graphite particles have a surface area of at least 120 m²/g.

The high surface area expanded graphite particles are surprisingly effective reinforcing agents for a variety of organic polymers. In particular, the high surface areas expanded graphite particles are unexpectedly effective in increasing the electroconductivity of many organic polymers, even when used in relatively low concentrations in a composite.

### BRIEF DESCRIPTION OF THE DRAWINGS

FIG. 1 is a transmission electron micrograph of an embodiment of the composite of the invention.

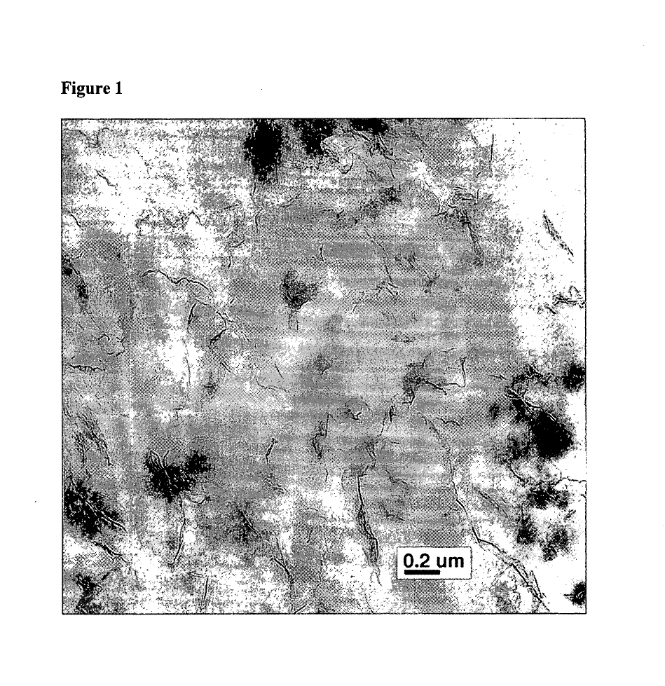

FIG. 2 is a transmission electron micrograph of another embodiment of the composite of the invention.

### DETAILED DESCRIPTION OF THE INVENTION

Graphites can be characterized as layered planes of carbon atoms. Within the planes, the carbon atoms form connected hexagonal structures. Adjacent planes are bonded through weak van der Wals forces. The graphitic structure is often characterized as having the planes aligned along a pair of orthogonal a axes, and a c axis that is perpendicular to the planes. The expanded graphite used in the invention is expanded along the so-called c axis, i.e., perpendicular to the planes. This results in an increase in the surface area of the expanded graphite. The expansion process also introduces a significant amount of oxygen into the graphite layers.

The expanded graphite suitably has a BET (Brunauer, Emmett and Teller) surface area of at least 120 m²/g. A more preferred expanded graphite has a BET surface area of at least 250 m²/g. A still more preferred expanded graphite has a BET surface area of at least 400 m²/g. An especially preferred expanded graphite has a BET surface area of at least 650 m²/g. The upper limit on the BET surface area may be in principal up to about 2700 m²/g, which is the approximate theoretical surface area of fully expanded graphite. However, expanded graphite having a surface area up to about 1500 m²/g, up to about 1200 m²/g or even up to about 900 m²/g, is suitable. For purposes of this invention, the BET surface area measurement can be made using 30% nitrogen in helium, at a P/P₀ ratio of 0.3. A variety of commercially available devices are useful for measuring BET surface area, including a Micromeritics TRISTAR 3000 device and a Quantachrome Monosorb tester. Samples are suitably outgassed prior to making the measurements, with suitable conditions being 200° C. at atmospheric pressure. An average of multiple data points can be used to determine the BET value.

The expansion of the graphite tends to increase the volume of the material per unit weight. The expanded graphite preferably is one that has been expanded to a volume of at least 100 cc/g. Volumes of at least 200 cc/g are preferred and volumes of at least 300 cc/g are even more preferred. It is recognized, however, that post-expansion treatments such as milling or grinding may have a very significant effect on the volume of the expanded graphite material.

Still another indication of the degree of expansion is provided by wide angle X-ray spectroscopy (WAXS). Unexpanded graphite exhibits an intense crystalline peak at a d-spacing of about 3.36±0.02 Angstroms (about 26.5 degrees 2θ for copper Kα radiation). This peak is associated with the intra-planar spacing of the natural graphite, which is typically on the order of 0.34 nm. The intensity of the peak is an indication of the degree to which this inter-planar spacing is retained. The expansion of the graphite leads to a separation of at least some of the layers. The separation of the layers during the expansion process can lead to a shift of the 3.36±0.02 crystalline peak and a diminution of its intensity. A preferred expanded graphite exhibits no measurable peak at 3.36±0.02 d-spacing that corresponds to the graphite inter-layer spacing. WAXS is conveniently performed for purposes of this invention using a Bruker D-8 or Rigaku MiniFlex diffractometer with a Cu Kα radiation source, although other commercially available diffractometers are also useful.

A preferred expanded graphite has a BET surface area of at least 250 m²/g and a volume of at least 100 cc/g. A more preferred expanded graphite has a BET surface area of at least 450 m²/g, a volume of at least 100 cc/g and no detectable WAXS diffraction peak at 3.36±0.02 d-spacing. An even more preferred expanded graphite has a volume of at least 100 cc/g, a BET surface area of at least 650 m²/g and no detectable WAXS diffraction peak at 3.36±0.02 d-spacing.

Expanded graphite can be prepared by intercalating graphite particles with a volatile expanding agent, drying it to remove excess liquids, and then heating the intercalated material to a temperature sufficient to turn the expanding agent into a gas. The expansion of the gas produced in this manner forces the layered planes of the graphite apart, thereby reducing the density and increasing the surface area.

The starting graphite material preferably has an average particle size of at least 50, more preferably at least 75 microns. The starting graphite material preferably has an average particle size up to about 1000 microns, more preferably up to 500 microns. Smaller particles tend to expand less due to the loss of expansion agent at their edges. Larger particles are more difficult to intercalate fully with the expansion agent.

Expandable graphite flakes and/or powders are commercially available and can be used as starting materials, but in most cases require further treatment with the additional intercalating materials (as described below) in order to expand to the extent needed in this invention. Examples of such expandable graphite products are available commercially under the tradenames GRAFGuard® 160-50N (from GRAFTech Inc., Advanced Energy Technologies Division, Parma, Ohio) and HP-50 (from HP Material Solutions, Northridge, Calif.). The GRAFGuard 160-50N product is intercalated with nitric and sulfuric acids, and is believed to further contain an organic acid and alkanol reducing agent. The intercalated materials are believed to constitute from 20 to 30% by weight of the expandable graphite product. These can be expanded by heating to the aforementioned temperature ranges, but usually expand only to produce surface areas somewhat under 50 m²/g, unless treated with additional expanding agents.

The expanding agent includes suitably includes a mineral acid such as sulfuric acid or nitric acid in combination with a strong oxidant such as potassium chlorate, potassium permanganate and/or hydrochloric acid. Combinations of sulfuric acid and nitric acid are preferred, and a mixture of such a combination with a strong oxidant, particularly potassium chlorate, is particularly preferred. The acids are preferably used in a concentrated form. Potassium chlorate and other oxidants are preferably dissolved in one or both of the concentrated mineral acids.

Certain organic acids may be used as expansion aids in conjunction with the aforementioned expanding agents, as described, for example, in U.S. Pat. No. 6,416,815. Organic reducing agents, in particular aliphatic alcohols, can also be used, also as described in U.S. Pat. No. 6,416,815. The graphite may contain a small quantity of ash.

An expanded graphite of particular interest is made by intercalating native graphite or an expandable graphite flake as just described with a mixture of sulfuric and nitric acids, optionally further with potassium chlorate and hydrochloric acid. The use of these materials as expansion agents is described generally by Staudenmaier in Ber. Dtsch. Chem. Ges. 1898, 31 p. 1484.

The various expansion agents can be added to the graphite all at once, or in various increments. In a preferred method of intercalating the graphite, the graphite is first treated with an excess of a mineral acid, preferably a mixture of nitric or sulfuric acids, optionally in the presence of an organic acid and/or reducing agent. “Excess” in this context means an amount greater than can be absorbed by the graphite. This treatment may be repeated one or more times. Potassium chlorate and/or potassium permanganate is then added to the acid/graphite mixture, preferably controlling the exotherm to prevent premature vaporization and/or reaction of the intercalating agents. The potassium chlorate or permanganate dissolves into the acid and is carried into the layer structure of the graphite. The mixture is conveniently maintained at about room temperature for a period of about 4 hours to 200 hours or more, particularly, 10 hours to 150 hours and especially 20 hours to 120 hours. Higher temperatures may be used if the intercalating agents do not volatilize or react.

The ability to form very highly expanded graphite materials appears to be related to the length of time that the graphite is exposed to the intercalating materials. Thus, the formation of expanded graphite products having surface areas of 120 m²/g or more is favored by longer treatment times. This is even more the case when the desired surface area is 250 m²/g or 400 m²/g or 650 m²/g or more. Characteristics of the starting material, such as particle size, purity and whether any pre-treatments have been performed, also affect the degree of expansion that is obtained.

After the intercalation process is completed, the product is conveniently washed with water and/or mineral acid solution, filtered and dried. As before, drying conditions are preferably mild, such as a temperature of 60° C. or less and atmospheric pressure, in order to prevent premature expansion of the graphite through the volatilize or degradation of the intercalating materials.

Temperatures in the range of 160° C. to about 1100° C. or more can be used, depending on the selection of the expanding agent. A temperature in the range of 600° C. to 1100° C. is generally preferred. A temperature of 900-1100° C. is especially preferred. The graphite particles are preferably heated very rapidly to the expansion temperature. Heating can be performed in various manners, such as by placing the particles into a heated oven or by applying microwave energy to the particles

The expanding agents tend to be strong oxidants, and the expanded graphite product tends to be somewhat oxidized. An expanded graphite material having a degree of oxidation is considered to be within the scope of the invention. A graphite that is intercalated with these expanding agents may contain as much as 50% oxygen by weight (of the graphite less intercalating materials). A typical amount of oxygen in the intercalated sample is from 20 to 40% by weight. During the expansion process, some of this oxygen is lost in the form of water, carbon dioxide and other species, so the expanded graphite more typically contains from about 10 to about 25% by weight oxygen.

The expanded graphite produced by this process typically assumes a vermiform (worm-like) appearance, with a longest particle size generally in the range of about 0.1 to about 10 millimeters. The expanded graphite particles are often referred to as “worms”. These expanded graphite particles can be used directly without further treatment to reduce particle size. It is also within the scope of the invention to mill the worms to produce smaller particle size particulates.

In this invention, the expanded graphite is dispersed within an organic polymer to provide physical property reinforcement, a measure of electroconductivity, or both. The amount of the expanded graphite in the polymer composite may range from about 1% by weight up to 50% by weight or more, based on the weight of the composite. A more typical loading of the expanded graphite particles is from about 1 to about 20% by weight. A more preferred loading of the expanded graphite particles is from about 1 to about 10% by weight.

An advantage of the invention is that the expanded graphite particles are very efficient at providing a desirable level of electroconductivity to the composite, and thus can be used at low loadings for that purpose. A preferred composite of the invention therefore contains from 1 to 8%, especially from 2 to 6% and more preferably from 2 to 5% by weight of the expanded graphite particles. These loads are often sufficient to reduce the volume resistivity of the composite to 1×10⁶ ohm-cm or below, preferably to 1×10⁴ ohm-cm or below. The organic polymer also influences the electroconductive properties of the composite, and so it may require more or less of the expanded graphite to impart volume resistivities within these ranges in particular cases.

The organic polymer may be of any type into which the expanded graphite can be dispersed. Examples of suitable polymers include, for example:

a. polyolefins such as high density polyethylene, low density polyethylene, linear low density polyethylene, metallocene-catalysed polyethylene, polypropylene, copolymers of ethylene and/or propylene with a C₄₋₁₂ α-olefin and the like;

b. poly(vinyl) aromatic polymers such as polystyrene, poly(vinyl toluene), poly(vinyl naphthylene), poly(chlorostyrene) and the like;

c. acrylic and acrylate polymers, including polymers and copolymers of (meth)acrylic acid; alkyl(meth)acrylates such as methyl-, ethyl-, n-butyl- and n-hexyl(meth)acrylate and the like; hydroxyalkyl(meth)acrylates such as hydroxyethyl(meth)acrylate and hydroxypropyl(meth)acrylate; acrylamide; and the like;

d. poly(vinyl alcohol), poly(vinyl chloride), poly(vinylidene chloride), poly (vinyl acetate), copolymers of two or more of the foregoing or of at least one of these with at least one other copolymerizable monomer (such as an ethylene-vinyl acetate copolymer);

e. random or block copolymers of two or more ethylenically unsaturated monomers, including copolymers of two or more ethylenically unsaturated monomers as described in a-c above, such as styrene-acrylate polymers, styrene-acrylonitrile copolymers and the like;

f. rubber-modified thermoplastic resins such as styrene-butadiene-acrylonitrile resins;

g. synthetic rubbers such as styrene-butadiene rubbers, polybutadiene rubbers, EPDM (ethylene propylene diene monomer) rubbers, butadiene-nitrile rubbers, polyisoprene rubbers, acrylate-butadiene rubbers, polychloroprene rubbers, acrylate-isoprene rubbers, ethylene-vinyl acetate rubbers, polypropylene oxide rubbers, polypropylene sulfide rubbers, and thermoplastic polyurethane rubbers;

h. polyesters such as poly(ethylene terephthalate), poly(butylene terephthalate), poly(caprolactone), polylactic acid, polyglycolic acid, and polymers of one or more polycarboxylic acids such as succinic acid, adipic acid, terephthalic acid, isophthalic acid, trimellitic anhydride, phthalic anhydride, maleic acid, maleic acid anhydride and fumaric acid with one or more polyols such as ethylene glycol, 1,2- and 1,3-propylene glycol, 1,4- and 2,3-butane diol, 1,6-hexane diol, 1,8-octane diol, neopentyl glycol, cyclohexane dimethanol, 2-methyl-1,3-propane diol, glycerine, trimethylol propane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and the like.

i. polycarbonates, polyacetals, polyamides such as nylon 6 and nylon 6,6, and the like;

j. polyethers of various types, including polymers and copolymers of ethylene oxide, propylene oxide, 1,2-butylene oxide, 2,3-butylene oxide, styrene oxide and the like;

i. epoxy resins, epoxy novalac resins, polyurethanes, polyisocyanurate resins, polyureas, polyurethane-ureas and the like.

j. phenolic resins such as phenol-formaldehyde resins;

k. other types of thermoplastic or thermosetting resins.

A composite of the expanded graphite particles in the organic polymer can be prepared using several methods. Some methods may not be applicable to forming composites with all types of polymers, and so the selection of a particular preparation method will be made taking into account the particular polymer that will be used. In general, however, composites according to the invention can be made by (a) a melt blending process, in which the expanded graphite particles are mixed into a melt of the organic polymer; (b) a solution blending process, in which the expanded graphite is mixed into a solution of the organic polymer in some suitable solvent; (c) a dry blending process, in which the expanded graphite particles are blended with solid particles of the organic polymer; (d) polymerization of a monomer or oligomer (or mixture of two or more monomers and/or oligomers) in the presence of the expanded graphite particles or (e) blending the expanded graphite particles into a curable resinous composition which is subsequently cured in the presence of the expanded graphite particles. Combinations of the foregoing approaches may be used.

In a melt blending process, the organic polymer is brought to a temperature above its melting temperature and mixed with the expanded graphite particles. The mixing may be done in any suitable mixing device including, for example, in the barrel of an extruder, a Brabender mixer or other compounding equipment. This method can be used with most thermoplastic polymers that melt at a temperature below the decomposition temperature of the polymer. The method is more suitable with respect to organic polymers that have somewhat lower melt viscosities, as low melt viscosities facilitate the wetting out of the graphite particles and penetration of the polymer into the inter-planar regions of the expanded graphite. The method is also preferred in instances where the polymer is not conveniently polymerized or cured in the presence of the expanded graphite particles, due to, for example, the conditions required to effect the polymerization and curing.

In a solution process, the polymer is dissolved in a suitable solvent and the expanded graphite particles are blended into the resulting solution. The expanded graphite particles may be slurried into a portion of the solvent before being blended with the polymer solution. The choice of solvent is made in conjunction with the particular polymer and of course the solvent should not be one that reacts with or dissolves the expanded graphite. In most instances, the solvent is preferably relatively low-boiling, so it can be easily volatilized from the product. Higher-boiling solvents can be used, and can be removed by volatilization or extraction methods. Solution blending processes are particularly useful in cases where the organic polymer has a high melt viscosity, and/or when the organic polymer is prone to degradation or other undesirable reactions at its melt temperature. The amount of solvent is selected to provide a solution having a workable solution viscosity.

A dry blending process is suitable in cases in which the organic polymer is a particulate solid at room temperature (˜22° C.) and will be subjected to a subsequent melt processing operation. In such cases, a powdered or pelletized polymer can be blended with the expanded graphite particles, with care being taken to obtain a uniform mixture. In general, dry blending can be used in any instance in which a particular organic polymer will be subsequently melt processed. Examples of such subsequent melt processing operations include, for example, extrusion, injection molding, blow molding, prepreg formation, pultrusion, casting, and the like. An advantage of dry blending is that a uniform mixture of the expanded graphite and polymer particles can be formed on a somewhat macroscopic level. In this way, problem of distributing the expanded graphite into a viscous molten polymer or the need to use solvents to disperse the expanded graphite can be avoided. During subsequent melt processing operations, the polymer wets out the graphite particles and penetrates within inter-planar spaces of the expanded graphite. The dry blending process is therefore particularly advantageous in cases where it is difficult to disperse the expanded graphite particles into the molten polymer (due to viscosity considerations or processing rate concerns, for example), and/or when it is undesirable or unfeasible to use a solution blending approach.

In another blending method, the expanded graphite particles are dispersed into a monomer or polymerizable oligomer that is subsequently polymerized in the presence of the expanded graphite particles to form the composite of the invention. The advantage of this method is that the monomer or monomer mixture is often a liquid at room temperature or a mildly elevated (for example, up to 50° C.) temperature and tends to be a low viscosity fluid. The low viscosity facilitates dispersion and wetting of the expanded graphite particles. The subsequent polymerization process is suitably one that is carried out under some form of agitation or other conditions such that the graphite particles remain dispersed during the polymerization process. If desired, the monomer may be dissolved in some suitable solvent, which may be desirable if the monomer is a solid at room temperature, or if the monomer is a viscous liquid at the temperature at which the dispersion is formed. In such cases, using a solution of the monomer often permits the dispersion to be formed at lower temperatures, which may help to prevent premature polymerization. If the monomer is a solid at room temperature, it is also possible to form a dry blend of the monomer with the expanded graphite, in a manner analogous to that described before.

Examples of monomers or polymerizable oligomers include ethylenically unsaturated monomers such as ethylene and α-olefins, vinyl aromatic monomers, acrylic, acrylate, methacrylic and methacrylate monomers, acrylonitrile, conjugated dienes such as butadiene and isoprene, polymerizable cyclic esters, amides and ethers such as lactones, lactide, glycolide, cyclic alkylene terephthalates, caprolactone, caprolactam, ethylene oxide, propylene oxide, 1,4-butylene oxide, styrene oxide and the like. Mixtures of two or more of the foregoing monomers can be used to make random copolymers, in cases in which the monomers are copolymerizable.

Similarly, the expanded graphite particles can be dispersed into a curable resin or other polymer precursor, which is then cured or otherwise caused to react in the presence of the expanded graphite particles to form the organic polymer. Examples of such resins or polymer precursors include, for example, epoxy resins, epoxy novalac resins, hardeners for epoxy or epoxy novalac resins, polyisocyanates and isocyanate-terminated prepolymers (which can be cured with water, polyol compounds or polyamine compounds to form polyurethane and/or polyurea polymers), polyol compounds (including polyether polyols, polyester polyols and other compounds having two or more hydroxyl groups or more per molecules) which can be cured with polyisocyanates and isocyanate-terminated prepolymers to form polyurethanes, and the like.

It is often convenient for several reasons to use a masterbatch process to introduce the expanded graphite into the organic polymer. The masterbatch is a dispersion of the expanded graphite in the organic polymer, monomer or precursor, in which the concentration of the expanded graphite particles is more concentrated than that desired in the final composite. During use, the masterbatch is ‘let down” into another material, such as more of the same polymer, monomer or polymer precursor, or a different polymer or different monomer. Let-down ratios are selected so that the desired level of the expanded graphite is present in the final product. A let-down weight ratio of from 0.5 to 20 parts of additional polymer, monomer or polymer precursor to 1 part masterbatch, especially about 1-10:1 and more preferably about 2-6:1 is often convenient. If a masterbatch is formed using a monomer or polymer precursor, the monomer or polymer precursor may be polymerized or otherwise advanced to form a low or high molecular weight polymer dispersion before being let down. This may be beneficial, for example, by increasing the viscosity of the molten masterbatch somewhat so it more closely matches that of another polymeric material, impact modifier or rubber, so that the materials are more easily and efficiently blended together during the let-down process.

In most instances, the presence of the expanded graphite particles will significantly reduce the volume electroconductivity of the composite, relative to that of the organic polymer alone. The extent to which this occurs depends of course on the organic polymer itself, the loading of the expanded graphite in the composite, how well the expanded graphite particles are distributed within the polymer matrix, and other factors. However, many organic polymers that as neat materials have volume resistivities on the order of 1×10¹⁰-1×10¹² ohm-cm or more will form composites with the expanded graphite in which the volume resistivity is reduced by 6 or more orders of magnitude, even at low to moderate loadings of the expanded graphite. Higher expanded graphite loadings can reduce the volume sensitivities by 7, 8 or even 9 orders of magnitude, or more. In many cases, reductions in volume resistivity of these magnitudes can be achieved in a composite containing from 1 to 8% of the expanded graphite. In preferred cases, comparable reductions in volume resistivity are seen at expanded graphite loadings of only 2 to 5%. In more preferred cases, these reductions in volume resistivity are seen at expanded graphite loadings of 2 to 4%.

A preferred composite therefore contains from 1 to 8% by weight of the expanded graphite particles, and has a volume resistivity of at least 6 orders of magnitude less than that of the unfilled organic polymer. A more preferred composite contains from 2 to 5% expanded graphite and has a volume resistivity at least 7 orders of magnitude less than that of the unfilled organic polymer. An even more preferred composite contains from 2 to 4% expanded graphite and has a volume resistivity of at least 8 orders of magnitude less than that of the unfilled organic polymer. On an absolute basis, it is preferred that the composite has a volume resistivity of 1×10⁶ ohm-cm or less. A more preferred composite has a volume resistivity of 1×10⁵ or less and an even more preferred composite has a volume resistivity of 1×10⁴ ohm-cm or less. Volume sensitivities are measured, for purposes of this invention, according to ASTM D-4496. In most applications, it is not necessary that the composite have a volume resistivity of less than 1.0×10² ohm-cm.

The expanded graphite particles also modify the physical and thermal properties of the composite. Of particular interest for many applications are properties such as heat sag and heat distortion temperature under load (DTUL). In general, heat sag is improved (i.e. the composite exhibits less sag upon testing) and the DTUL is increased, relative to the unfilled polymer. For many applications the composite should exhibit a heat sag, as measured according to ASTM D3769, of no greater than 6 mm, preferably no greater than 4 mm, after heating at 200° C. for 30 minutes. An especially preferred composite exhibits a heat sag of less than 3 mm under those conditions. It is preferred that the composite exhibits these heat sag values when the expanded graphite constitutes 2% or more of the weight of the composite, such as from 2 to 8% of the composite weight.

The DTUL of the composite will depend greatly on the choice of organic polymer. For many applications, the composite preferably exhibits a heat distortion temperature under load of at least 140° C., preferably at least 160° C. and more preferably at least 170° C., as measured according to ASTM D648.

The presence of the expanded graphite particles tends to increase tensile modulus, relative to that of the unfilled polymer. For many applications the composite suitably exhibits a tensile modulus of at least 2 GPa, preferably at least 3 GPa and more preferably at least 3.5 GPa. As is the case with other properties, these values will depend heavily on the selection of the organic polymer.

The composite for many applications suitably exhibits a coefficient of linear thermal expansion (CLTE), as measured according to ASTM D696, of no greater than 150×10⁻⁶ cm/cm/° C., more preferably no greater than 100×10⁻⁶ cm/cm/° C. and especially no greater than 80×10⁻⁶ cm/cm/° C. These heat distortion and CLTE values usually can be achieved in some embodiments with this invention (again depending to a significant extent on the organic polymer) when the expanded graphite constitutes 2% or more of the weight of the composite, such as from 2 to 8% of the composite weight.

For many applications, the composite suitably exhibits a storage modulus (G) as measured according to ASTM D5279-01 of at least 90 MPa throughout the temperature range of 20-200° C. These storage modulus values can be achieved with some embodiments of this invention when the expanded graphite constitutes 2% or more of the weight of the composite, such as from 2-8% of the composite weight.

The following examples are provided to illustrate the invention, but are not intended to limit the scope thereof. All parts and percentages are by weight unless otherwise indicated.

### EXAMPLE 1

50 g of an acid-intercalated graphite (GRAFGuard 160-50N) is added to a 3-necked flask 255 ml of concentrated sulfuric acid is added, followed by 135 ml of concentrated nitric acid. The mixture is chilled to 0-5° C. with stirring. 137.5 g of potassium chlorate is added in small portions, maintaining the temperature below 10° C. Following the addition of the potassium chlorate, the temperature of the mixture is raised to about 22° C. and held at that temperature for about 100 hours. This mixture congeals into a black foamy sludge during that time. Gas is vented from the flask, and 300 ml concentrated sulfuric acid is added with stirring for 30 minutes. The mixture is then added to 14 L of deionized water, and stirred for five minutes. The intercalated (and oxidized) graphite settles out of the aqueous phase and is removed by filtration. The filter cake is washed with two-1000 ml portions of 5% HCl and four-1000 ml portions of deionized water. The filter cake is then broken into ˜1 cm pieces and dried for two days at 60° C. The dried material is then chopped, sieved through a 10 mesh screen, and dried overnight under vacuum at 60° C. to produce a dry, granular material.

The dried material is expanded under nitrogen in a 975° C. electric tube oven for about 3 minutes. The resulting expanded graphite material is cooled in the oven to 75° C. and removed. The material is then chopped in a Waring blender at high speed for about 10 seconds.

This expanded graphite material has a BET surface area of over 700 m²/g. On WAXS, this material shows almost the complete absence of a peak at 3.36±0.02 d-spacing.

48.5 grams of cyclic butylene terephthalate oligomer (CBTO) and 1.5 grams of GRAFTech GPB expanded graphite worms are dried in a vacuum at 100° C. for 2 hours. The dried materials are then added to approximately 100 ml of chloroform in a beaker and sonicated using a sonication horn at 400 watts power for 20 minutes. The solvent is then removed by rotoevaporation and the remaining product dried in a vacuum oven overnight at 100° C. The resulting powdered blend is added to a HAAKE blender at 250° C. and held at that temperature for two minutes to allow the oligomer to melt. At that point, 0.160 g of butyltin chloride dihydroxide catalyst (0.3 mol %) is sprinkled into the blender and the oligomer is allowed to polymerize to polybutylene terephthalate (PBT) for 10 minutes. The resulting composite is then removed, grounded into granules and placed in a vacuum oven for 12 hours at 195° C. to advance the molecular weight of the polymer. The composite is then remelted at 250° C. in a melt index machine to obtain a strand for volume resistivity measurement.

The resulting composite contains 3% by weight expanded graphite particles and has a volume resistivity of 2.65×10³ ohm-cm.

A second composite is made on a larger scale, using an oligomer/expanded graphite blend made from 480 grams of the CBTO and 20 grams of the expanded graphite (4% by weight expanded graphite). The volume resistivity measures 2.28×10² ohm-cm when tested on a melt index strand and 6.53×10³ ohm-cm when tested on an injection molded bar.

### EXAMPLE 2

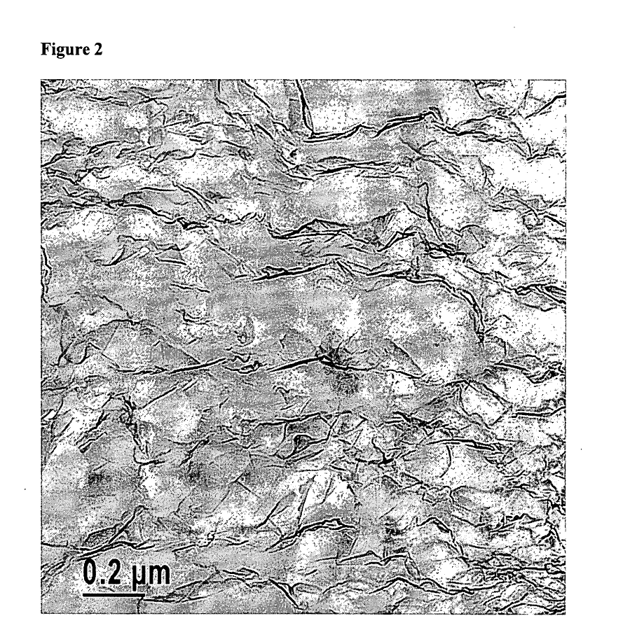

An expanded graphite having a surface area of about 702 m²/g is made using the general method described in Example 1. A powdered cyclic butylene terephthalate macrocyclic oligomer is dry blended with this material and 0.34% by weight distannoxane (0.3 moles/mole of macrocyclic oligomer) to provide a mixture containing 4% by weight expanded graphite. The mixture is starve-fed using a screw-type powder feeder into a reactive extrusion (REX) process to produce a composite. The REX process equipment consists of a co-rotating twin screw extruder (Werner Pfleiderer and Krupp, 25 mm, 38 L/D) equipped with a gear pump, a 1″ (2.5 cm) static mixer (Kenics), a 2.5″ (6.25 cm) filter (80/325/80 mesh) and a two-hole die downstream. The feeder and hopper are padded with inert gas during operation. The extruder is operated at 200-300 rpm, 15 lb/hr (6.8 kg/hr), and the temperature profile is increased from 50° C. in the initial section to 250° C. over the latter sections of the extruder and downstream process equipment. This provides sufficient mixing in the initial sections for dispersing the filler and sufficient residence time in the latter sections to complete the polymerization. Pellets produced in this manner are then subjected to solid state polymerization (SSP) in a vacuum oven at 200° C. for 26 hours. The resulting composite is Example 2. FIG. 2 is a transmission electron micrograph of composite Example 2.

Test bars are molded from composite Example 2 using a 28 ton Arburg injection molding machine. Molding conditions are barrel temperature—260° C.; nozzle temperature—270° C.; mold temperature—82° C.; fill time—˜1.3 seconds; cooling time—30 seconds.

For comparison, test bars are molded from an unfilled polymer of the macrocyclic oligomer.

The tensile modulus and electrical conductivities of the test bars are measured. Results are as reported in Table 1.

TABLE 1

| | | Expanded | | |
|---|---|---|---|---|
| | Wt-% | Graphite | Tensile | Volume |
| | Expanded | Surface Area, | Modulus, psi | Resistivity, |
| Example No. | Graphite | m²/g | (10⁵ Pa) | ohm cm |
| 2 | 4 | 702 | 4.99 | 6.55 × 10³ |
| Unfilled* | 0 | N/A | 3.7 | >1 × 10¹² |

*Not an example of this invention.

As can be seen from the data presented in Table 1, the presence of 4% by weight of the expanded graphite particles results in a decrease in volume resistivity of over 8 orders of magnitude (10¹² ohm-cm vs<10⁴ ohm-cm). Tensile modulus is increased by about 35%.

### EXAMPLE 3

Using the general process described in Example 1, multiple samples of GRAFGuard 160-50N acid-intercalated graphite particles are further intercalated with additional acid and potassium chlorate. Treatment times vary from 5 hours to 96 hours. Five-gram samples of the various intercalated graphite particles are expanded in the general manner described in Example 1, at 1000° C. for 30 seconds in air.

Samples treated for 5 hours expand to form an expanded graphite having a surface area of 102 m²/g. Samples treated for 23 hours expand to assume a surface area of 275 m²/g. Samples treated for 96 hours expand to assume a surface area of 702 m²/g. A second sample that is not chopped prior to treatment (and thus has about a 1 cm particle size) is also treated for 96 hours, and assumes after expansion a surface area of 433 m²/g. These experiments establish a correlation between treatment time (under the stated conditions) and surface area of the expanded graphite product, as well as a relation between graphite particle size and the degree of expansion.

Fifty-gram samples of both chopped and unchopped material that is treated for 96 hours are expanded in the same manner. Surface areas are 448 m²/g for the chopped material and 429 m²/g for the unchopped material.

A sample of the GRAFGuard 160-50 expandable graphite is expanded under the same conditions, resulting in a material having a surface area of 16 m²/g.

A sample of HP Materials 50 expandable graphite is expanded under the same conditions to produce a material having a surface area of 40 m²/g. HP Materials 80 expandable graphite forms an expanded product having a surface area of 37 m²/g.

The expanded materials are chopped in a Waring blender to pass through 10 mesh screen and subsequently dried at 60° C. prior to use.

A dispersion of the expanded graphite in a macrocyclic oligomer is prepared by mixing 7.5 g of the 433 m²/g expanded graphite sample and 400 g of chloroform in a 1 liter vessel. The mixture is treated with a high-speed rotor/stator homogenizer (Tekmar Company, Model SDT) to disperse the graphene into the liquid. A stir bar is then added and the black suspension is treated with an ultrasonic probe (Fisher Scientific, Model 550 Sonic Dismembrator) at 400 W for 10 minutes while stirring on a magnetic stir plate. 142.5 g of cyclic butylene terephthalate macrocyclic oligomer is added and the resulting suspension is stirred to dissolve the oligomer. The sonication is then repeated with the oligomer present. The resulting suspension is poured into a 2 liter flask and the chloroform removed via rotary vacuum evaporation (Buchi RotaVapor). The flask is then placed in a vacuum oven overnight at 130° C. to remove residual chloroform. The flask is cooled and the contents are removed by scraping from the flask. The final mixture contains 5 weight percent of the expanded graphite. It is diluted with additional macrocyclic oligomer to produce a mixture containing 3 weight percent of the expanded graphite.

The resulting mixture is polymerized using the general method described in Example 1, to form Composite Example 3.

Comparative Sample A is prepared in the same manner, using the expanded GRAFGuard 160-50 material having a surface area of 34 m²/g instead of the 433 m²/g material used to produce Composite Example 3. The mixture is used at an expanded graphite concentration of 5% by weight.

Comparative Sample B is prepared in the same manner as Comparative Sample A, except that the mixture is diluted with additional macrocyclic oligomer to an expanded graphite concentration of 4% by weight.

Comparative Sample C is prepared by mixing 4 parts by weight of the expanded GRAFGuard 160-50 material having a surface area of 34 m²/g and 96 parts by weight of molten cyclic butylene terephthalate macrocyclic oligomer. This mixture is then polymerized as described in Example 1.

Comparative Sample D is prepared in the same manner as Composite Example 3, using the expanded HP Materials 50 product having a surface area of 40 m²/g instead of the 433 m²/g material used to produce Composite Example 3. The mixture is used at an expanded graphite concentration of 5% by weight. Comparative Samples E and F are made in the same manner as Comparative Sample D, except the expanded graphite concentrations are 4% and 3%, respectively.

Volume resistivities for Composite Example 3 and Comparative Samples A-F are determined, and are as reported in Table 2.

TABLE 2

| | | Expanded | |
|---|---|---|---|
| Example or | Surface Area of | Graphite | |
| Comparative | Expanded | Concentration, | Volume Resistivity, |
| Sample No. | Graphite | wt-% | ohm-cm |
| 3 | ???? | 3 | 2.7 × 10³ |
| A | 34 | 5 | 2.3 × 10³ |
| B | 34 | 4 | 1.2 × 10⁶ |
| C | 34 | 4 | 2.2 × 10⁴ |
| D | 40 | 5 | 2.5 × 10² |
| E | 40 | 4 | 2.5 × 10⁴ |
| F | 40 | 3 | 1.3 × 10⁵ |

The data in Table 2 shows how the higher surface area expanded graphite material is more effective in reducing volume resistivity than the lower surface area materials. Composite Example 3 and Comparative Sample F have comparable loadings of expanded graphite, yet the lower surface area material produces a composite that has a volume resistivity about 50 times greater than that of Composite Example 3. The 34 m²/g expanded graphite material can provide a composite (Comparative Sample A) having a volume resistivity similar to that of Composite Example 3, but it requires a loading of 5% of the expanded graphite in order to achieve this, rather than the 3% loading of Composite Example 3. The data shown for Composite Examples B and C establish the volume resistivity increases rapidly as the level of 34 m²/g surface area expanded graphite is reduced to 4 weight percent.

### EXAMPLE 4

An expanded graphite having a surface area of about 754 m²/g is made using the general method described in Example 1. 0.3 grams of the expanded graphite is added and mixed into 7.57 grams of a diglycidyl ether of bisphenol A having an epoxy equivalent weight of about 176-183 (D.E.R.™ 383, from The Dow Chemical Company). The mixture is then out-gassed in a vacuum oven for 30 minutes to remove entrapped air. 2.13 grams of Ancamine DL-50 epoxy harder (available from Air Products) is then added to the mixture and the mixture is cured in a vacuum oven at 200° C.

The resulting composite contains 3% by weight expanded graphite and has a volume resistivity of 1.73×10³ ohm-cm. Additional composites in epoxy resin are made at 1, 2 and 4% by weight. The volume resistivities are summarized in Table 3. FIG. 2 is a transmission electron micrograph of the composite containing 3% by weight of the expanded graphite.

| Wt % Expanded | Volume Resistivity, |
|---|---|
| Graphite | ohm-cm |
| 1 | 1.59 × 10¹¹ |
| 2 | 5.73 × 10⁶ |
| 3 | 1.73 × 10³ |
| 4 | 3.01 × 10² |

It will be appreciated that many modifications can be made to the invention as described herein without departing from the spirit of the invention, the scope of which is defined by the appended claims.

What is claimed is:

1. A composite comprising a matrix of an organic polymer, the polymer matrix having dispersed therein at least about 1% by weight of expanded graphite particles, based on the weight of the composite, wherein the graphite particles have a surface area of at least 120 m²/g.

2. The composite of claim 1, wherein the expanded graphite particles have a surface area of at least 250 m²/g and a volume of at least 100 cc/g.

3. The composite of claim 2, which contains from 2 to 6% by weight of the expanded graphite particles.

4. The composite of claim 3, wherein the expanded graphite particles have a surface area of at least 450 m²/g, a volume of at least 100 cc/g and no detectable WAXS diffraction peak at 3.36±0.2 d-spacing.

5. The composite of claim 4 which has a volume resistivity 1×10⁶ ohm-cm or less.

6. The composite of claim 5 wherein the expanded graphite particles have a surface area of at least 650 m²/g.

7. The composite of claim 6 which contains from 2 to 5% by weight of the expanded graphite particles.

8. A dispersion of expanded graphite particles in a polymerizable monomer, the dispersion containing at least about 1% by weight of expanded graphite particles, based on the weight of the dispersion, wherein the graphite particles have a surface area of at least 120 m²/g.

9. The dispersion of claim 8, wherein the expanded graphite particles have a surface area of at least 250 m²/g and a volume of at least 100 cc/g.

10. The dispersion of claim 9, which contains from 2 to 6% by weight of the expanded graphite particles.

11. The dispersion of claim 10, wherein the expanded graphite particles have a surface area of at least 450 m²/g, a volume of at least 100 cc/g and no detectable WAXS diffraction peak at 3.36±0.2 d-spacing.

12. The dispersion of claim 11 wherein the expanded graphite particles have a surface area of at least 650 m²/g.

13. The dispersion of claim 12 which contains from 2 to 5% by weight of the expanded graphite particles.

14. A dispersion of expanded graphite particles in a curable resin composition, the dispersion containing at least about 1% by weight of expanded graphite particles, based on the weight of the dispersion, wherein the expanded graphite particles have a surface area of at least 120 m²/g.

15. The dispersion of claim 14, wherein the expanded graphite particles have a surface area of at least 250 m²/g and a volume of at least 100 cc/g.

16. The dispersion of claim 9, which contains from 2 to 6% by weight of the expanded graphite particles.

17. The dispersion of claim 16, wherein the expanded graphite particles have a surface area of at least 450 m²/g, a volume of at least 100 cc/g and no detectable WAXS diffraction peak at 3.36±0.2 d-spacing.

18. The dispersion of claim 17 wherein the expanded graphite particles have a surface area of at least 650 m²/g.

19. The dispersion of claim 18 which contains from 2 to 5% by weight of the expanded graphite particles.

20. A polymerization process comprising subjecting a dispersion of expanded graphite particles in at least one polymerizable monomer to conditions sufficient to polymerize the monomer to form a composite comprising a polymer matrix of the polymerized monomer, the polymer matrix having dispersed therein at least about 1% by weight of expanded graphite particles having a surface area of at least 120 m²/g.

21. The polymerization process of claim 20 wherein the expanded graphite particles have a surface area of at least 250 m²/g and a volume of at least 100 cc/g.

22. The polymerization process of claim 21, wherein the polymer matrix contains from 2 to 6% by weight of the dispersed expanded graphite particles.

23. The polymerization process of claim 22, wherein the expanded graphite particles have a surface area of at least 450 m²/g, a volume of at least 100 cc/g and no detectable WAXS diffraction peak at 3.36±0.2 d-spacing.

24. The polymerization process of claim 23 wherein the polymer matrix is a polyolefin, a poly(vinyl) aromatic polymer, an acrylic or acrylate polymer, a poly(vinyl alcohol), a poly(vinyl chloride), a poly(vinylidene chloride), a poly (vinyl acetate), a random or block copolymer of two or more ethylenically unsaturated monomer, a rubber-modified thermoplastic resin, or a synthetic rubber.

25. The polymerization process of claim 24 wherein the expanded graphite particles have a surface area of at least 650 m²/g.

26. The polymerization process of claim 25 wherein the polymer matrix contains from 2 to 5% by weight of the dispersed expanded graphite particles.

27. A process comprising forming a dispersion of expanded graphite particles in a curable resin composition, and curing the resin composition in the presence of the expanded graphite particles, wherein the dispersion contains at least about 1% by weight of expanded graphite particles, and the expanded graphite particles have a surface area of at least 120 m²/g.

28. The process of claim 27 wherein the expanded graphite particles have a surface area of at least 250 m²/g and a volume of at least 100 cc/g.

29. The process of claim 28, wherein the curable resin composition contains from 2 to 6% by weight of the dispersed expanded graphite particles.

30. The process of claim 29, wherein the expanded graphite particles have a surface area of at least 450 m²/g, a volume of at least 100 cc/g and no detectable WAXS diffraction peak at 3.36±0.2 d-spacing.

31. The process of claim 30 wherein the curable resin composition is an epoxy resin, epoxy novalac resin, polyurethane-forming composition, polyisocyanurate-forming composition, polyurea-forming composition, or polyurethane-urea-forming composition.

32. The process of claim 31 wherein the expanded graphite particles have a surface area of at least 650 m²/g.

33. The process of claim 32 wherein the curable resin composition contains from 2 to 5% by weight of the dispersed expanded graphite particles.
